(19) United States
(12) Patent Application Publication
(10) Pub. No.: US 2026/0315201 A1
(43) Pub. Date: Oct. 15, 2026

(54) ULTRASONIC SCALER

(71) Applicant: RDK COMPANY LLC, Coto De Caza, CA (US)

(72) Inventors: Jinous ESLAMI, Coto De Caza, CA (US); Derek BORSODY, Ottawa Hills, OH (US); Darin BOLOURIAN, Coto De Caza, CA (US)

(21) Appl. No.: 19/482,800

(22) PCT Filed: May 13, 2024
(86) PCT No.: PCT/US2024/029165

§ 371 Date: Nov. 10, 2025

Related U.S. Application Data
(60) Provisional application No. 63/501,489, filed on May 11, 2023.

(51) Int. Cl. A61C 17/20; A61C 17/02

(52) U.S. Cl. CPC A61C 17/20; A61C 17/0202

(57) ABSTRACT

An apparatus includes a scaler tip comprising a working end configured to engage and remove plaque, calculus, and other debris from teeth. The scaler tip includes a nozzle configured to direct irrigation fluid toward the working end of the scaler tip. The apparatus includes a base unit including a fluid reservoir, a pump, a motor driver, and control electronics for controlling the operation of the pump and the motor driver. The apparatus also includes a handheld unit including a handle portion configured to be handheld. The handheld unit can be configured to receive and secure the scaler tip so that the scaler tip can be manipulated through handheld motion of the base unit. The apparatus also includes a cable connecting the base unit to the handheld unit. The cable includes a fluid conduit and one or more wires.

### RELATED APPLICATION

This application claims the benefit of priority of U.S. provisional application 63/501,489, filed May 11, 2023, the disclosure of which is hereby incorporated by reference in its entirety.

### TECHNICAL FIELD

The invention relates to dental hygiene products, specifically ultrasonic scalers.

### BACKGROUND

Dental anxiety is a common phenomenon, with sensitivity being one of the contributing factors. The fear of experiencing pain during dental cleanings can deter individuals from seeking regular dental care, even though such care is essential for managing sensitivity and preventing further oral and systemic health issues. The role of dental scalers are instruments used by dental professionals during cleanings to remove plaque, tartar, and calculus from teeth and gumline. For individuals with sensitive teeth, the buildup of plaque and tartar can exacerbate discomfort and increase sensitivity. Sensitivity in one's teeth can stem from a variety of sources, such as gum recession, teeth whitening, and dental restorations. Compounding this reluctance are the demands of maintaining oral health in cases of dental implants and gum disease. Dental implants and gum disease often necessitate more frequent dental cleanings to prevent complications and maintain oral health. Implants require meticulous care to prevent peri-implantitis, an inflammatory condition that can lead to implant failure. Similarly, gum disease, such as gingivitis or periodontitis, requires ongoing management to prevent progression and preserve the supporting structures of the teeth. Regular scaling at home can help alleviate this discomfort by ensuring thorough removal of these deposits, thereby reducing the risk of inflammation and sensitivity.

Traditionally, floss has been used to clean in between teeth. The dental floss is usually in the form of a nylon or plastic filament that which removes food particles and other debris in the interproximal areas of teeth. If this material is allowed to remain in the interdental spaces, bacteria can form and harden to become plaque and calculus. Plaque and calculus cannot be removed by traditional flossing, brushing (hand-powered or electric), or other instruments, such as powered water flossers or irrigators. If left untreated, plaque and calculus can lead to gum disease. Metal tools are commonly used in dental cleanings, they can pose challenges for people with sensitivities and may inadvertently damage dental implants, restorations, and gum tissue, causing bacterial buildup and irritation. Thus, at-home use of these metal tools is discouraged.

As a result, professional dental cleanings are administered at the dentist's office, using a variety of instruments to remove plaque and calculus buildup from teeth. Dentists and dental hygienists employ the use of scalers, which are pointed metal instruments that are hard enough to scrape away plaque and calculus. Scalers can either be handheld manual tools that the user manipulates by hand to scrape away the plaque/calculus. Powered instruments, such as ultrasonic scalers, are substantially faster and remove the plaque/calculus more thoroughly. When used to clean dental implants and/or dental restorations, scalers can cause damage, which can create issues ranging from bacterial infection to loss of implants to increased sensitivity. Professionals are skilled at avoiding these issues, whereas the laypeople are not.

Due to their ease of use, electric powered water flossers or irrigators have gained popularity over traditional flossing when it comes to plaque removal. Water flossers have a tip from which a stream of pulsating, high-pressure water or other liquid is directed between teeth to remove food particles and other debris. Still, water flossers are not effective at removing hardened plaque or calculus, which are more challenging to remove. Studies have shown, however, that individuals with limited hand strength and dexterity—typically children, elderly patients, medically handicapped patients, and housebound or bedridden patients, can see real benefits in using water flossers as opposed to conventional cleaning. Moreover, the integration of home scalers designed specifically for individuals with limited strength and dexterity can further enhance oral hygiene routines for these patients. This home scalers will be designed with ergonomic handles and lightweight construction, making it easier to grip and maneuver for individuals who may struggle with traditional dental instruments. Additionally, this home scalers may feature adjustable settings to accommodate varying levels of cleaning needs while eliminating any sensitivity or discomfort.

Dental hygiene routine is important for just not teeth, but for overall health as well. Ultrasonic scalers can help bridge the gap between traditional brushing/flossing and professional cleaning. A powered scaler with water irrigation has advantages of plaque removal regardless of the plaque hardness or whether impacted food particles are in a more challenging location. Powered scalers combine ease of use and efficiency, both of which are attractive to personal, at-home use.

Additionally, when using ultrasonic scalers, special care must be exercised when cleaning dental implants as to avoid damaging, e.g., chipping or scratching, the implant. Research has shown that damaged implant surfaces create areas for bacteria to collect, and an increased bacterial population leads to increased corrosion. Accordingly, there exists a need for improvements that allow for ultrasonic teeth scaling with improved patient comfort and a reduced potential for damage, both by professionals and through self-administration.

Traditional ultrasonic scalers implement a metal scaler tip that chips away at plaque and calculus deposits from the teeth. Oscillating at ultrasonic frequencies, the scaler tip is used to scrape or otherwise dislodge plaque and calculus from the teeth in a highly efficient and effective manner. While ultrasonic scaler tips are highly effective at removing plaque and calculus, they also can cause discomfort in those with highly sensitive teeth and/or gums. This is due to the metal component of the scaler. While the metal scaler is an important tool for maintaining oral health, its use can sometimes cause discomfort or pain, particularly when it comes into contact with sensitive areas of the teeth and gums. The areas with the greatest sensitivity have been noted as those near receding gum lines, dental restorations, and dental implants. For those with sensitive teeth, a great deal of discomfort can be associated with teeth cleaning procedures.

Reluctance to undergo professional cleanings or other dental procedures due to past experiences of discomfort or pain, it can have negative consequences for their oral health. Without regular cleanings, oral bacteria can build up, leading to plaque and tartar accumulation, gum disease, tooth decay, and other oral health issues. Furthermore, research has shown that oral health is closely linked to systemic health, meaning that poor oral health can increase the risk of certain systemic conditions such as cardiovascular disease, diabetes, and respiratory infections. Conditions like gingivitis and periodontal disease may necessitate more frequent dental cleanings. To address the hesitation arising from teeth and gum sensitivity, modifications to the ultrasonic scaler tip have been proposed. The goal is to reduce sensitivity, prevent damage to dental restorations and implants, and enhance the cleaning effects.

### SUMMARY

A dental instrument in the form of an ultrasonic scaler with a plastic scaler head and water irrigation for home use, allows for efficient and effective teeth cleaning while minimizing discomfort, making it much more likely that a dental patient will keep up with their routine visits and maximize their dental health at home. This advancement and efficiency promotes oral health outcomes and contributes to overall systemic health and well-being. Encouraging consumers to embrace these advancements and prioritize regular dental visits can lead to long-term benefits for both oral and systemic health. The scaler includes a scaler tip that is both effective and durable, and can be used on both teeth and implants without the fear of damaging the surfaces of either. The ultrasonic scaler assists users in maintaining their oral hygiene by removing plaque and calculus, which can help reduce the time and effort that dentists and hygienists require for professional cleaning. Routine user-initiated cleaning will also help improve and maintain comfort levels, as the user will become accustomed to the scaling procedure and improve their oral hygiene, making routine dental visits shorter, less intense, and more pleasant.

The scaler tip employed by the ultrasonic scaler combines the gentleness and reduced abrasion of a plastic/polymer material with the rigidity and cleaning power of a metal tip. The scaler tip can be 3D printed as an all-plastic design or insert molded as a plastic covered metal design. In either instance, the scaler tip can retain the rigidity and effectiveness of an all-metal design.

The ultrasonic scaler includes an integrated water spray and irrigation nozzle that aids in the cleaning process by washing away the plaque and calculus removed by the scaler tip. This speeds up the cleaning process and provides a comfortable experience for the user.

A control unit to which the ultrasonic scaler is connected regulates both the ultrasonic driver of the scaler tip and the water supplied to the nozzle. Manually actuated switches control the frequency at which the scaler tip vibrates/oscillates as well as the pressure/flow of the water supplied to the spray nozzle. Scaling can be performed with or without spray irrigation.

According to one aspect, an apparatus includes a scaler tip comprising a working end configured to engage and remove plaque, calculus, and other debris from teeth. The scaler tip includes a nozzle configured to direct irrigation fluid toward the working end of the scaler tip. The apparatus includes a base unit including a fluid reservoir, a pump, a motor driver, and control electronics for controlling the operation of the pump and the motor driver. The apparatus also includes a handheld unit including a handle portion configured to be handheld. The handheld unit can be configured to receive and secure the scaler tip so that the scaler tip can be manipulated through handheld motion of the base unit. The apparatus also includes a cable connecting the base unit to the handheld unit. The cable includes a fluid conduit and one or more wires. The handheld unit includes a housing and a motor for imparting oscillating or vibratory motion to the scaler tip when secured to the handheld unit. The motor is operable in response to the motor driver. The handheld unit also includes a fluid conduit configured to deliver irrigation fluid to the scaler tip so that the nozzle can direct a spray of the irrigation fluid toward the working end of the scaler tip. The handheld unit also includes one or more user control inputs for communicating control commands to the control electronics of the base unit via the one or more wires of the cable. The scaler tip includes a polymer material that forms the working end of the scaler tip.

According to another aspect, alone or in combination with any other aspect, the scaler tip can have a curved configuration in which the working end terminates with a working edge configured to engage and remove the plaque, calculus, and debris. The nozzle can be configured to direct the irrigation fluid spray toward the working edge.

According to another aspect, alone or in combination with any other aspect, the oscillating or vibratory motion imparted to the scaler can be is linear.

According to another aspect, alone or in combination with any other aspect, the motor can include one of an eccentric weight vibration motor, a piezoelectric motor, and a magnetostrictive drive.

According to another aspect, alone or in combination with any other aspect, the housing can include a handle portion and a threaded body at a working end of the handle portion. The threaded body can be configured to receive a threaded collar for securing the scaler tip to the housing. The threaded body can include a fluid conduit configured to deliver irrigation fluid to the scaler tip. The scaler tip can include a base forming an annular shoulder configured to engage the collar to secure the scaler tip to the threaded body with a bottom surface of the scaler tip engaging an end surface of the threaded body. The threaded body can have a wall thickness that is at least double a wall thickness of the handle portion of the housing. According to this aspect, the wall thickness of the threaded body is at least 3-6 times the thickness of the wall thickness of the handle portion of the housing.

According to another aspect, alone or in combination with any other aspect, the housing can include first and second housing portions configured to be connected to define the handle portion. The threaded body can be formed on one of the housing portions only.

According to another aspect, alone or in combination with any other aspect, the scaler tip can include an irrigation port that extends from the base to the nozzle and is configured to deliver irrigation fluid from the handheld unit to the nozzle. According to this aspect, the threaded body can be configured to apply the oscillating or vibratory motion to the fluid passing through the channel so that waves are imparted in the fluid.

According to another aspect, alone or in combination with any other aspect, the handheld unit can include a collar configured to engage an annular shoulder of the base of the scaler tip and to secure the scaler tip to the handheld unit via a compressive force that urges the scaler tip against the threaded body.

According to another aspect, alone or in combination with any other aspect, the motor can be configured to directly engage an end surface of the threaded body opposite the end surface engaging the scaler tip.

12. The apparatus recited in claim 1, wherein the scaler tip comprises a stainless steel insert coated with the polymer material that forms the working end.

According to another aspect, alone or in combination with any other aspect, the scaler tip can be formed completely of the polymer material that forms the working end.

According to another aspect, alone or in combination with any other aspect, the scaler tip can also include a channel for receiving irrigation fluid from the nozzle, the channel being configured to direct the irrigation fluid toward the working end.

According to another aspect, alone or in combination with any other aspect, the oscillating of vibratory motion can be applied at an ultrasonic frequency. According to this aspect, the oscillating of vibratory motion can be applied at a frequency of 20-50 kHz. The frequency can be selectable to be continuous or pulsed. The frequency can be modulated to one or more patterns.

### DRAWINGS

FIG. 1 illustrates a system and apparatus including an ultrasonic scaler, according to an example configuration.

FIG. 2 is a perspective view, partially in phantom, illustrating a portion of the system and apparatus.

FIG. 3 is a schematic illustration of the system and apparatus.

FIG. 4 is an exploded perspective view of a scaler portion of the system and apparatus.

FIGS. 5A and 5B are sectional views of the scaler portion of the system and apparatus.

FIGS. 6A-6D are side, top, bottom, and end views, respectively, of the scaler portion of the system and apparatus.

FIGS. 7A and 7B are top and bottom perspective views, respectively, of a scaler tip portion of the scaler, according to one example configuration.

FIGS. 7C-7F are top, bottom, rear, and side views, respectively, of the scaler tip of FIGS. 7A and 7B.

FIG. 8 is a sectional view illustrating another example configuration of the scaler portion of the system and apparatus.

FIGS. 9A and 9B are top and bottom perspective views, respectively, of a scaler tip according to another example configuration.

### DESCRIPTION

### Ultrasonic Scaling System

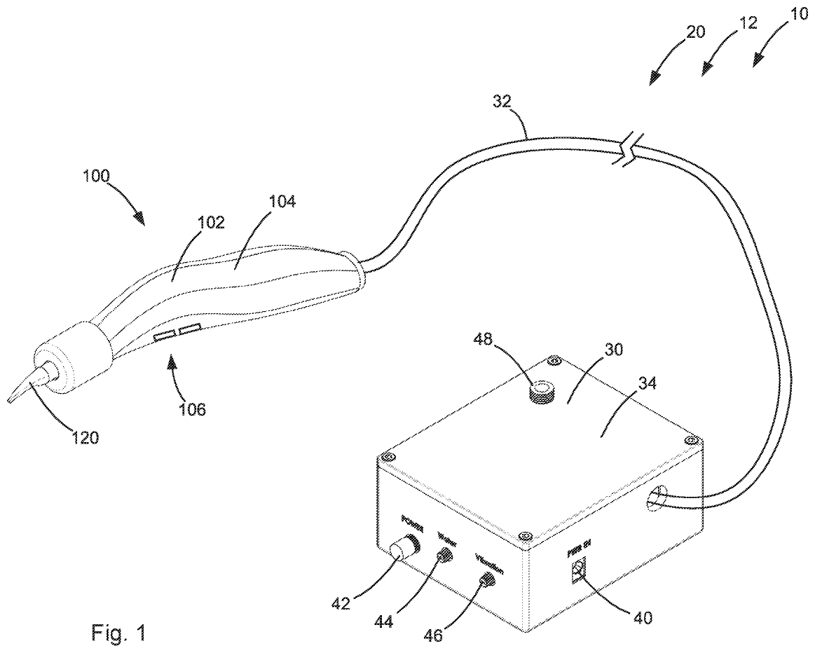

Referring to FIG. 1, an ultrasonic scaling system 10 includes an apparatus 12 in the form of an ultrasonic scaling unit 20. The ultrasonic scaling unit 20 includes a base unit 30 and a handheld ultrasonic scaling unit 100, which is referred to herein as a scaler. The scaler 100 is connected to the base unit 30 by a cable 32 that includes electrical conductors, i.e., wires, and a fluid conduit, such as a flexible tube. The base unit 30 is configured to deliver electricity for powering the scaler 100, to deliver pressurized irrigation fluid to the scaler, and to deliver control signals between the base unit and the scaler. These details will be discussed in further detail below.

The base unit 30 includes a housing 34 that supports internal components that drive the operation of the ultrasonic scaling unit 20. The base unit 30 also includes a power receptacle 40 for receiving power from a power cable (not shown). Controls on the base unit 30 include a power switch 42 for powering on/off the unit, a water control switch or knob 44, and a vibration switch or knob 46. The water control switch 44 allows the user to activate/adjust water pressure delivered to the scaler 100. The vibration control switch 46 allows the user to activate/adjust the vibration frequency at which the scaler 100 operates. A fill port 48 allows for filling a reservoir that contains a fluid (e.g., water) that is used by the scaler to irrigate and rinse the area being cleaned.

The scaler 100 includes a housing in the form of a body 102 that is ergonomically designed to form a handle 104 for holding and manipulating the scaler during the cleaning/de-scaling process. A scaler tip 120 is supported at the end of the body 102 and is configured to be driven by components supported within the body 102 to vibrate at an ultrasonic frequency selected to dislodge the plaque/calculus from the teeth. The drive components supported within the body 102 are themselves controlled and driven by the base unit 30 through the wiring and fluid conduit of the cable 32, which also facilitates communication to the base unit from user interface (UI) features 106, such as one or more buttons, lights/LEDs, and a screen (e.g., LCD or LED) for indicating device status, modes, water pressure, vibration frequency, etc. For example, the screen can indicate one or more modes of operation, such as:
Vibrating the scaler and concurrently spraying the flow of high-pressure stream of liquid from the liquid spray nozzle at the same time.
Vibrating the scaler but not spraying any liquid from the liquid spray nozzle. In this mode, additionally, the vibration can be continuous while the spraying can be manually controlled via pushbutton on the handle.
Spraying the flow of high-pressure stream of liquid from the liquid spray nozzle but not vibrating the scaler. In this mode, additionally, the spray can be continuous while the vibration can be manually controlled via pushbutton on the handle.

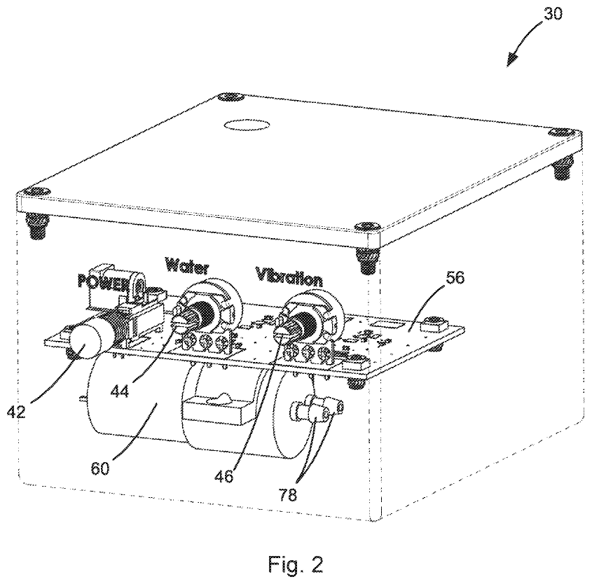

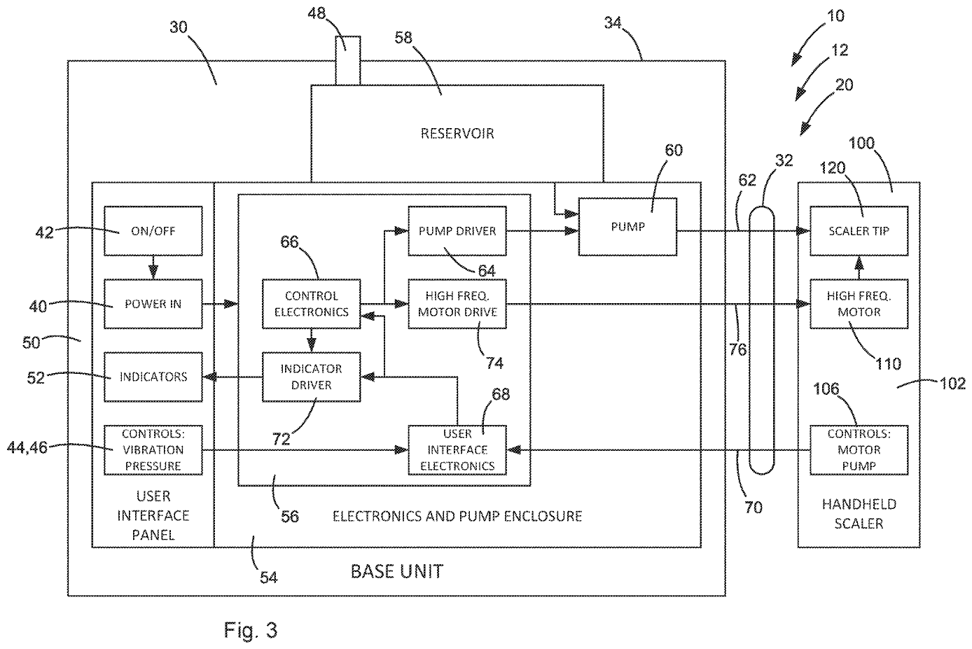

As shown in FIG. 2, the controls, i.e., the power switch 42, water control switch 44, and vibration control switch 46 can be mounted on a printed circuit board 56, which is supported in the housing 34. The printed circuit board 56 supports a variety of components, indicated generally at 36 in FIG. 2. These and other components of the system 10 and apparatus 12 are shown schematically in FIG. 3.

FIG. 3 is a schematic illustration of the ultrasonic scaling unit 20. As shown in this figure, the base unit 30 includes a user interface panel 50, which includes the power switch 42, the vibration controls 44 and the water pressure controls 46, supported on or otherwise connected to the printed circuit board 36. The interface panel 50 also includes various indicators 52, such as power ON, water pressure, vibration frequency, etc. An enclosure 54 supports the electronics and pump that control operation of the unit 20. Within the enclosure 54, various components can be supported on or in the vicinity of a printed circuit board 56. The configuration and arrangement of the components supported in the base unit 30 is not important, as long as they support the operation of the unit 20, as described herein.

The base unit 30 includes a reservoir 58 that receives water via the fill port 48. The reservoir 58 supplies water or any other liquid to a pump 60 which is connected to the scaler 100 by a conduit 62 of the cable 32. The pump 60 is also shown in FIG. 2, which also illustrates the fittings 78 for connecting to hosing or tubes that deliver water in from the reservoir 58 and out to the scaler 100 via the conduit 62. Within the scaler 100, the water is delivered to the scaler tip 120, as shown. The pump 60 is controlled by a pump driver 64, which is operated by control electronics 66. The control electronics 66 are operatively connected to user interface electronics 68 which issues commands based on inputs from the controls 44, 46 on the user interface panel 50 and the controls 106 on the scaler 100. To facilitate this, the user interface electronics 68 receives inputs from the scaler 100 via conductors 70 bundled within the cable 32. The control electronics 66 and the user interface electronics 68 provide inputs to an indicator driver 72, which controls the operation of the indicators 52 on the base unit 30.

The control electronics 66 also operate a high frequency motor driver 74, which provides an output that is delivered to the scaler 100 via conductors 76 bundled within the cable 32. In the scaler 100, a high frequency motor 110 receives the drive signal from the motor drive 74, which causes the motor to vibrate. The motor 110 is operatively connected to the scaler tip 120 so that the scaler tip vibrates at the same frequency as the motor.

The motor 110 is configured to impart vibration to the scaler tip 120, and can do so in a variety of manners, implementing a transducer that converts electrical energy to mechanical oscillatory/vibratory movement. For example, the motor 110 can be a magnetostrictive drive, which relies on magnetostriction to produce the vibratory motion. Magnetostriction is a property of magnetic materials that causes them to change their shape or dimensions during the process of magnetization. The variation of materials' magnetization due to the applied magnetic field changes the magnetostrictive strain, thus causing the material to convert the electrical energy used to produce the applied magnetic field to kinetic energy. A magnetostrictive implementation of the motor 110 produces movement in the form of vibration in response to the pulsed/oscillated nature of the electrical current applying the magnetization.

Magnetostrictive strictive elements produce heat due to the internal friction that results from the strain imparted to the material by magnetization. It is therefore necessary to provide a means for cooling not only the magnetostrictive structure in the body 102/handle 104, but also the scaler tip 120. It can therefore be advantageous to implement a motor 110 that generates less heat.

To help avoid the generation of heat and the need to provide cooling, as another example, the motor 110 can have a piezoelectric transducer configuration. Piezoelectric materials are solid state materials such as crystals, ceramics, or polymers that produce electric current in response to mechanical deformation. Conversely, piezoelectric materials also deform mechanically in response to the application of an electric current. It is in this implementation that the piezoelectric material can be used as the motor 110 to produce vibration. Piezoelectric materials produce less heat than magnetostrictive materials, so a piezoelectric implementation of the motor 110 requires water cooling only for the scaler tip 120. Because water is already used for irrigation, it can perform the dual function of irrigation and tip cooling.

Advantageously, the motion generated by the piezoelectric implementation of the motor 110 can be linear in nature, with the vibratory “strokes,” that is, the back-and-forth vibration movements occurring in a linear pattern. Driving the scaler tip 120 in a linear pattern can be advantageous in that it can reduce the volume of water that the system 10 requires for irrigation. Additionally, the reduction in the required volume of irrigation fluid will improve the ability to manage the water that is used by the system. This is because linear vibration movement, as opposed to the non-linear, circular/helical motion imparted by magnetostrictive drives, will not deflect the irrigation fluid, especially if the fluid is discharged parallel or close to parallel to the direction of the vibratory movement, i.e., along the axis of vibration.

The linear pattern produces through a piezoelectric implementation of the motor 110 requires a lower amplitude electric drive signal, which reduces the overall vibration imparted to the teeth. The linear vibration, which produces the desired cleaning/scaling effect, avoids the non-linear components of magnetostrictive drives that add unnecessarily to the applied vibrations. This lower amplitude and reduced vibration produces increased comfort.

The sides of the scaler tip 120 are the active parts that allow for more direct plaque removal without hitting unwanted tooth and gum structures. Unlike magnetostrictive scalers, the plaque and calculus removal from a piezoelectric scaler is not in bulk or chunks. Instead, the calculus disintegrates into small, e.g., sand-like, particles, which are easily washed out without any displeasure.

As a further example, the motor 110 can have a rotary vibration motor configuration. In this configuration, the motor 110 can produce rotation of an eccentric weight, which produces vibratory movement at a frequency equivalent to the speed/rate (RPMs) at which the motor is operated. The vibration motor, being mounted to the body 102 of the scaler 100, imparts vibration to the body and to the scaler tip 120 mounted thereto. The direction of the vibrations can be adjusted through the orientation of the motor 110. The magnitude of the vibrations can also be controlled through the mass of the eccentric weight. Through the selection of these features, the vibrations can be made to have linear characteristics or components configured to produce the desired movement of the scaler tip 120.

Like piezoelectric materials, the vibration motor produces less heat than magnetostrictive materials, so this implementation of the motor 110 requires water cooling only for the scaler tip 120. Because water is already used for irrigation, it can perform the dual function of irrigation and tip cooling.

Ultrasonic frequencies are defined generally as being those above 20 KHz, which is the upper limit of human audible detection. The system 10 and apparatus 12, being described herein as an ultrasonic scaler 20, therefore implements a motor 110 that oscillates at frequencies above 20 KHz. In one example configuration, the ultrasonic scaler 20 can operate the motor in the 20-50 KHz range. The operating frequency can be adjusted through the vibration controls 46 on the base unit 30 within this range. In one implementation, the frequency can be selected or dialed-in to any frequency within that range. In another implementation, the vibration can be selected from discrete pre-defined settings, such as low (e.g., 20 kHz), medium (e.g., 30 kHz), and high (e.g., 40 kHz).

Additionally, the high frequency linear oscillation can be further varied in a variety of oscillating patterns. For example, the oscillation can be continuous or pulsed. The pulsed oscillation can be at set intervals, variable intervals, or random intervals.

In view of the configuration set forth in FIG. 3, an example method of operation for the scaling unit 20 would be that the user powers on the unit via the switch 42 on the base unit 30. The user then dials-in the desired water pressure and vibration frequency via the controls 44, 46 on the UI panel 50 of the base unit 30. Holding the scaler 100 via the handle portion 104, the user can control whether the scaler tip 120 vibrates and whether irrigation fluid is delivered via the controls 106 on the scaler. The user can then use the scaler 100 to clean their teeth and remove plaque/calculus with the scaler tip 120 with or without vibration and with or without irrigation, as selected via the controls 106.

### Scaler Tip

The scaler tip 120 has an improved construction, implementing a lowered surface hardness as to produce effective cleaning and plaque removal with improved user comfort, especially in the areas of implants and the sensitive cemental enamel junction.

The scaler tip 120 can be configured as a replaceable component that can be swapped over time due to wear. The scaler tip 120 can be configured for a variety of connection types that allow for swapping tips on/off the scaler body 102 easily and, preferably, without the need for tools. For example, the scaler tip 120 can be configured for twist-lock attachment to the scaler body 102, for a collared attachment to the scaler body, or even a magnetic attachment to the scaler body.

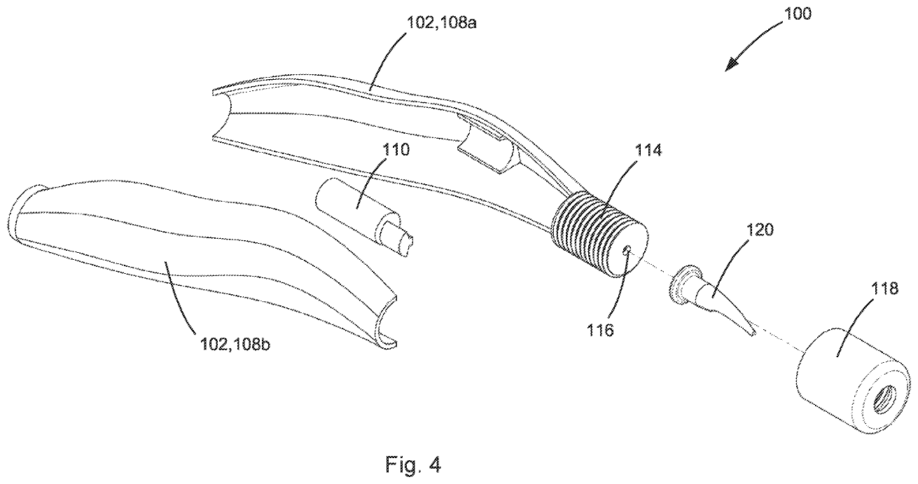

FIG. 4 illustrates the construction of the scaler 100. As shown, the body 102 is composed of two housing halves 108a, 108b that are fitted together to form the body. The housing halves 108a, 108b can be interconnected by any conventional means, such as a snap fitting, screws, etc., or a combination thereof. The housing halves 108a, 108b are not identical. The housing half 108a has features not included on the housing half 108b. First, the housing half 108a includes a seat 112 for securing the motor 110 to the body 102 in a rigid and secure manner, so that the vibrations are transferred to the body and to the scaler tip 120 in an efficient and reliable manner.

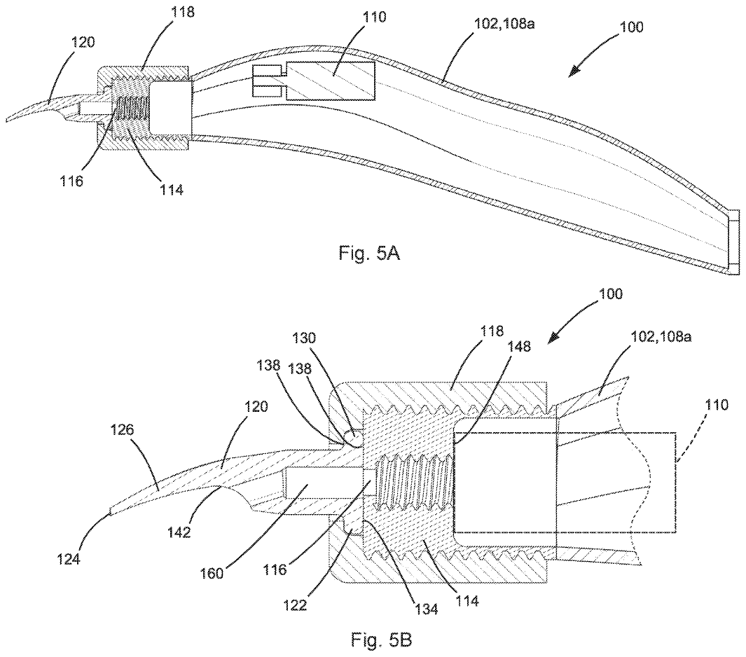

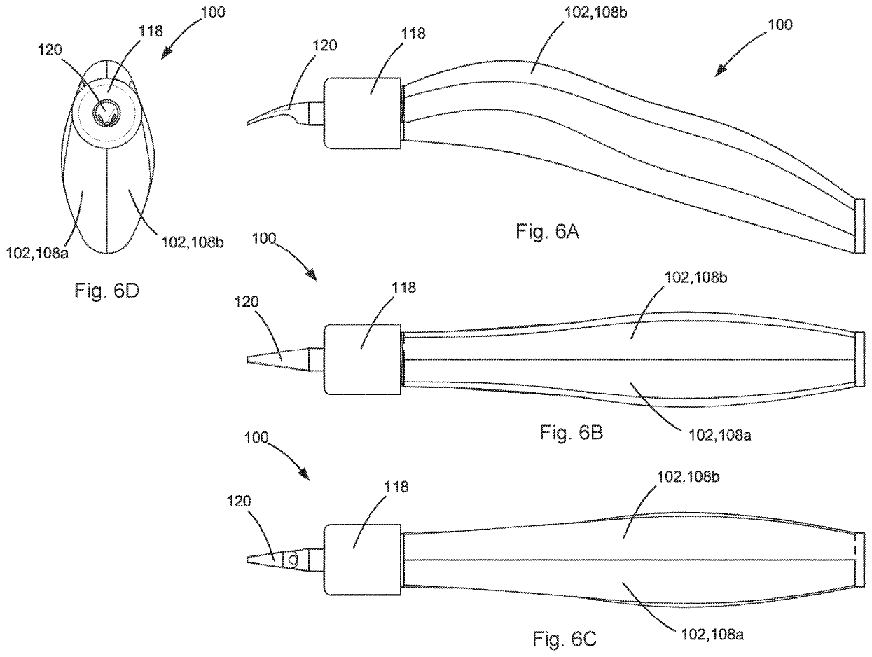

Referring to FIGS. 5A-5B and 6A-6D, the first housing half 108a also includes a threaded body 114 through which an irrigation conduit 116 extends. The threaded body 114 has a cylindrical configuration with external threads configured to mate and engage with a collar 118 that secures the scaler tip 120 to the scaler 100. The threaded body 114 is thick walled, forming a solid mass at the end of the scaler body 102 that is penetrated only by the irrigation conduit 116. The irrigation conduit 116 can include internal threads configured to receive a fitting that connects the fluid conduit 62 of the cable 32 (see FIG. 3) to the threaded body 114 so as to provide the irrigation fluid that is delivered to the scaler tip 120. The mass of the threaded body 114 can be maximized, that is, it can be limited only by the necessary area of the fluid conduit 116. The threaded body 114 can be as close to being a solid mass as possible/practical. The wall thickness of the threaded body 114 is measured between its threaded outer surface and the inner surface of the fluid conduit 116. The wall thickness of the threaded body 114 is at least double the walls of the housing halves 108a, 108b and can be as much as 3-6 times as thick, or more, than the housing halves, as shown in FIG. 5B.

Advantageously, the comparatively large mass of the threaded body 114 requires an equally large (again in comparison) collar 118. While the collar 118 is effective in its primary purpose, i.e., connecting the scaler tip 120 to the body 102, it also serves the purpose of providing a large diameter outer surface, which is easy to grasp by hand and to apply rotation for tightening/loosening the scaler tip 120. The scaler tip 120 can thus be connected and changed without the use of tools.

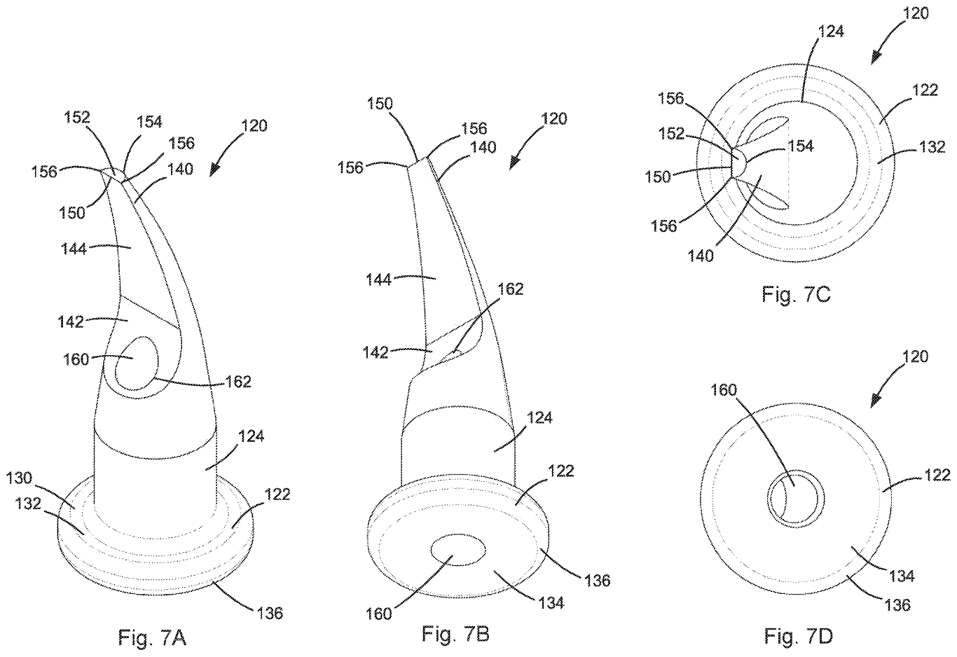

FIGS. 7A-7F illustrate a scaler tip 120 that is configured for a collared attachment to the scaler body 102. The scaler tip 120 includes a base 122, a central body portion 124, and a tip portion 126. The base 122 has a generally disc-shaped configuration and the body portion 124 has a cylindrical configuration with a diameter that is smaller than that of the base 122. The base thus forms an annular rim 130 that projects radially from the body portion 124.

The rim 130 defines an annular shoulder 132 on its upper surface. The base 130 has a lower surface 134 configured to engage the body 102 of the scaler 100. More specifically, the lower surface 134 is configured to mechanically engage the motor 110 so that vibrations/oscillations are transferred efficiently and accurately. To facilitate this engagement, the base 130 can include a rounding or chamfer 136 configured to promote the direct and mechanically sound engagement between the scaler tip 120 and the motor 110.

The tip portion 126 of the scaler tip 120 extends from the body portion 124 with a generally curved conical configuration that terminates at a distal working end 140. Along the tip portion 126, sections of this curved conical portion are removed, forming a port surface 142 and a tool surface 144. The port surface 142 and the tool surface 144 are curved surfaces that, along with the curved geometry of the tip portion 126 define the reach of the scaler tip 120. The working end 140 has a linear working edge 150 defined at the intersection of the tool surface 144 and a flat end surface 152 of the tip portion 126. The working end thus has a generally semi-circular configuration, with an arc-shaped edge 154 intersecting opposite ends of the working edge 150.

The scaling tip 120 can be about 30 mm in height, with the tip portion 126 having a radius of curvature of about 10-15 mm.

The working edge 150 acts in the manner of a chisel to scrape and dislodge plaque/calculus from the teeth surfaces. The intersections of the working edge 150 with the edge 154 form points 156 that can be used to access the interdental space between the teeth. Together, the working edge 150 and the points 156 combine to define an effective tool for plaque/calculus removal.

The scaler tip 120 also includes a central irrigation port 160 that extends from the lower surface 134 of the base 130 through the body portion 124 and into the tip portion 126. The irrigation port 160 exits the body portion 124 through the port surface 142, forming a discharge opening or nozzle 162 through which inflation fluid is directed toward the working area of the teeth. The base 130 is configured so that the irrigation port 160 engages a discharge from the pump 60.

The engagement of the scaler tip 120 with the scaler body 102 is best shown in FIGS. 5A and 5B. As shown, the threaded body 114 acts as an oscillating/vibrating element positioned at the distal end of the scaler body 102. The lower surface 134 of the base 130 of the scaler tip 120 is configured to engage a corresponding end surface 138 of the threaded body. The large surface areas of the engaging surfaces 134, 138 of the scaler tip 120 and threaded body 114 promote an efficient and effective transfer of the vibrations from scaler body 102 to the scaler tip 120.

Engaging portions of the scaler tip 120 and/or scaler body 102 can result in a dampening of the vibrations by the components (e.g., through thin walls). Transferring the vibrations through the more massive portions of the components helps promote the vibrations being transferred to the scaler tip 120. In fact, to further promote this efficient transfer of vibration from the scaler body 102 to the scaler tip 120, the motor 110 can be configured to engage an end surface 148 of the threaded body 114 opposite the end surface 138. In this manner, vibrations from the motor 110 are imparted directly to the threaded body 114 and transferred directly to the scaler tip 120 with no intervening structures in the vibration path.

Promoting the efficient and effective transfer of vibrations from the scaler body 102 to the scaler tip 120 is the collar 118, which engages the upper surface 132 of the rim 130 and urges the bottom surface 134 of the scaler tip 120 against the end surface 148 of the threaded body 114. At the same time, the engagement enforces a fluid tight engagement between the fluid conduit 116 and the irrigation port 160. The mass of the threaded body 114 can be maximized to promote these features. For example, the diameter of the fluid conduit 160 can be minimized, i.e., kept as small as possible without negatively effecting irrigation flow, so that the walls of the threaded body can have maximum thickness.

In operation, the working edge 150 of the scaler tip 150 forms the active cleaning side. The curvature of the tip portion 126 allows the working edge 150 to adapt to the direct facial or lingual of the tooth surface. This shape of the tip portion 126 is important to effective cleaning performance of the scaler 100. The curvature of the tip portion 126 in combination with the fine working edge 150 allows the user to reach between teeth, while efficiently cleaning the large surface of the teeth. Curvature also maximizes contact with the rounded faces of teeth. The design and material of this tip makes it user friendly by allowing an untrained person to have better control of the scaler tip to clean teeth surface without causing damage and discomfort to their gums, teeth, tooth restorations and dental implant.

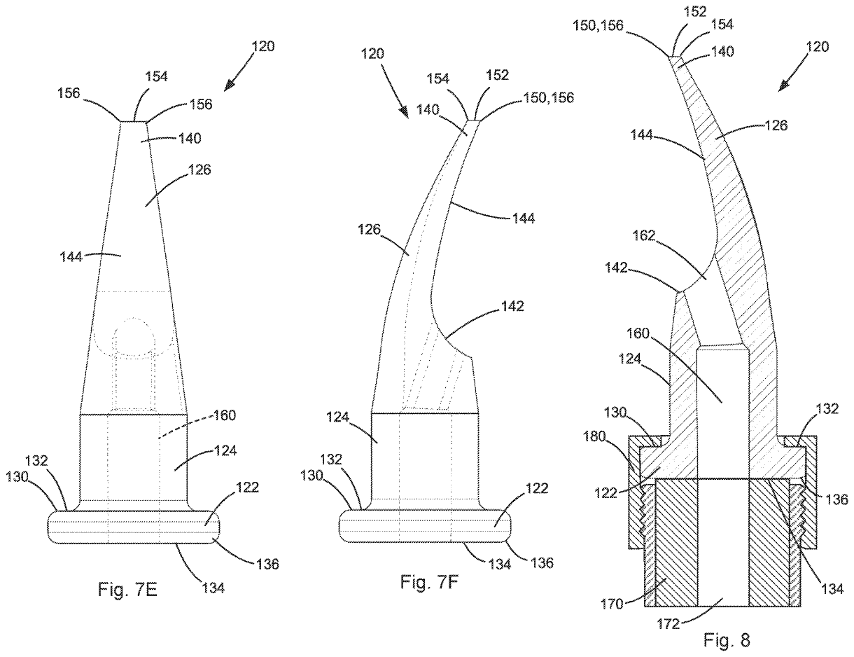

FIG. 8 illustrates another example configuration of the scaler 100. In this configuration, an oscillating/vibrating element 170 is positioned at the distal end of the scaler body 102. The element 170 can, for example, be a piezoelectric element of the motor 110 or a mechanical element linked to the piezoelectric element of the motor. As another example, the element 170 can be a vibrating/oscillating element of a magnetostrictive drive of the motor 110 or a mechanical element linked to the magnetostrictive element of the motor.

An irrigation conduit 172 extends through the element 170 or is otherwise positioned to engage with the irrigation port 160 within the scaler body 102. The irrigation conduit 172 directs water or other fluids from the pump 60 via the conduit 62 of the cable 32 into the irrigation port 160, which delivers the fluid to the work area on the teeth. In the example configuration of FIG. 8, the scaler 100 includes a collar 180 that secures the scaler tip 120 to the scaler body 102 through a threaded engagement with the scaler body. The collar 180 engages the upper surface 132 of the rim 130 and urges the bottom surface 134 of the scaler tip 120 against the oscillating/vibrating element 170 of the motor 110. At the same time, the engagement enforces a fluid tight engagement between the irrigation conduit 172 and the irrigation port 160.

The oscillating/vibrating element 170 can at least partially replace the threaded body in the configuration of FIG. 8. In the example configuration of FIG. 8, the scaler tip 120 will have a linear stroke pattern with the working edge 150 forming the active cleaning side, due to the linear nature of the vibrations created by the piezoelectric/magnetostrictive configuration of the element 170. The curvature of the tip portion 126 allows the working edge 150 to adapt to the direct facial or lingual of the tooth surface. This shape of the tip portion 126 is important to effective cleaning performance of the scaler 100. The curvature of the tip portion 126 in combination with the fine working edge 150 allows the user to reach between teeth, while efficiently cleaning the large surface of the teeth. Curvature also maximizes contact with the rounded faces of teeth. The design and material of this tip makes it user friendly by allowing an untrained person to have better control of the scaler tip to clean teeth surface without causing damage and discomfort to their gums, teeth, tooth restorations and dental implant.

The scaler tip 120 is constructed using fused deposition modeling (FDM) techniques, which provides a plastic/polymer-coated or all-plastic/polymer design that retains the rigidity of a metal tip. For example, in one configuration, the scaler tip 120 may include a stainless-steel core with a plastic coating (e.g., 0.1-0.5 mm thick). This will allow for crowns and other implants to be cleaned by the home-user without scratching or damage.

The scaler tip 120 can be formed as an all plastic unit by molding or 3D printing. In one example configuration, the scaler tip 120 can be produced via stereolithography (SLA), which is a 3D printing process that uses a light source to harden liquid resin into plastic in layers. The resin is cured with UV light during the printing process until the object is complete. The scaler tip 120 can also be formed as a plastic/polymer coated stainless steel unit by insert molding.

The materials used to form or coat the scaler tip 120 are designed to maintain their flexibility and durability even when molded into thin or intricate shapes. The plastic is bio-compatible because the tip is used in the oral cavity. In one example construction, polypropylene (PP) can be used. Polypropylene is versatile thermoplastic that is known for its flexibility and impact resistance (the most used plastics for the at home oral hygiene market). PEEK (Polyether Ether Ketone) is an ideal choice because of its high mechanical and thermal resilience. Additionally, PEEK needed the smallest geometry modification to resonate at the desired frequency. Polycarbonate derivatives are also an option due to reduced cost and similar mechanical properties. The fact that polycarbonate fails by shattering, however, makes it less desirable. Nylon offers much more favorable failure modes and deforms more before failure compared to PP, PC and PEEK. Nylon is the softest plastic considered and will likely lose its cleaning edge fastest.

From this, for an all-plastic/polymer configuration of the scaler tip 120, polypropylene can be implemented. Polypropylene has high durability, flexibility, and resistance to moisture, which makes it suitable for oral hygiene products and the Ultrasonic scaler. For a coated stainless steel configuration of the scaler tip 120, a PEEK coating can be implemented. In either instance, the following requirements, thresholds, and goals apply:

| Requirement | Threshold | Goal |
|---|---|---|
| Withstand | Withstands | Not exceeding 70% |
| Vibrations | 36.00+/−5.3 | of yield strength |
| | micrometers | throughout |
| | displacement | displacement |
| Resonate | Harmonic | Harmonic |
| at correct | within 3% of | between 25 kHz |
| frequency | 25 kHz | and 30 kHz |
| | and 30 kHz | |
| Toxicity | Plastic is | Plastic is non-toxic |
| | non-toxic | |
| Corrosion- | Metal can last | Metal can last 7 |
| Resistant | 7 or more | months without |
| | months without | corroding |
| | corroding | |
| Durable | Tip lasts 4 | Tip lasts 4-6 |
| | months | months |

Implementing either construction of the scaler tip 120, the scaler 100 will operate over a full frequency range of an ultrasonic scaler, 20-50 kHz, with a lower surface hardness, so as to avoid damaging dental implants.

In an example configuration, the pump 110 can deliver water to the scaler tip 120 at a pressure in the range of about 10-100 psi. The nozzle 162 can be configured to produce a stream diameter of several millimeters or less, such as 0.5-3.0 mm, with the pressure controlled to deliver fluid at a desired volumetric flow rate.

Because the water/fluid is delivered to the scaler tip 120 through the irrigation conduit 116 (or irrigation conduit 172 of the element 170), ultrasonic waves can be added to the water/fluid that is discharged through the nozzle 162, which can enhance the teeth cleaning. In fact, the irrigation conduit 116 of the threaded body 114 (or the irrigation conduit 172 of the element 170) can include surface features, such as one or more circumferential or helical ribs, that can promote pressure waves or pulsation within the irrigation stream. Advantageously, these waves/pulsations can be focused directly to the tooth surface, thereby aiding in removal of the plaque/calculus. In this unique configuration, both the scaler tip 120 and the fluid stream delivered from the nozzle 162, can be applied to the teeth with high frequency, ultrasonic oscillation/vibration/pressure waves. The frequencies with which these are delivered can be continuous or varying, and constant or patterned/intermittent.

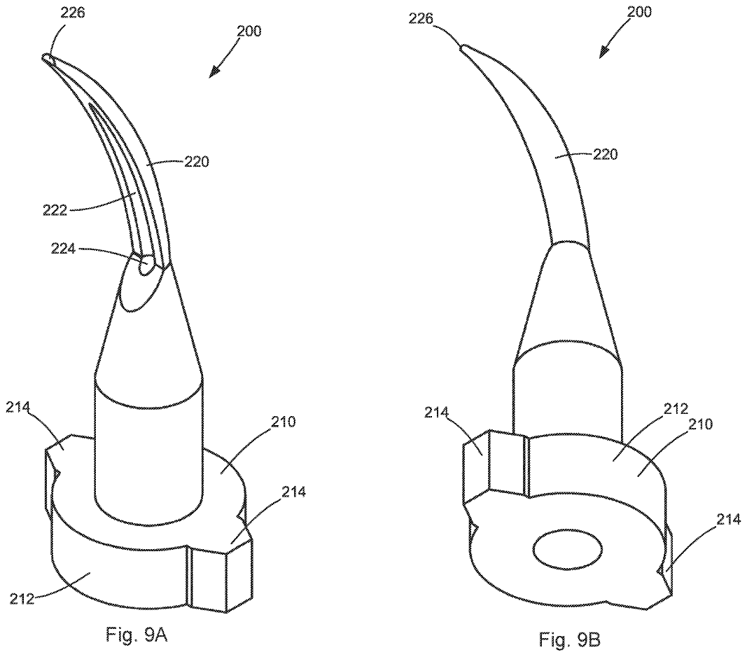

Another example configuration of the scaler tip is shown in FIGS. 9A and 9B. In this configuration, the scaler tip 200 has an overall configuration and material construction that is similar or identical to the example configuration of FIGS. 7A-7F. Accordingly, only the differences are described. Essentially, the scaler tip 200 differs in the configuration of the base 210 and the tip portion 220. The base 210 is configured for a twist lock attachment to the scaler body 102. The tip portion 220 is configured for a more focused delivery of irrigation fluid.

Being configured for twist-lock attachment, the base 210 includes an annular rim 212 with a pair of diametrically opposed key portions 214 that project radially from the rim. The keys 214 are configured to enter corresponding keyways that permit insertion of the base 210 into a connection chamber of the scaler body 102. Once installed in the connection chamber, the scaler tip 200 is twisted, causing the keys 214 to enter circumferential slots until they engage stop pieces that block further twisting and give positive feedback that the tip is fully installed. The slots can include angled surfaces that form an interference with the keys 214 so that the base 210 is firmly secured, with the base engaging the vibration element(s) 170 of the motor 110 to that oscillation/vibration is transferred to the scaler tip 200 in an efficient and effective manner.

The tip portion 220 of the scaler tip 200 includes a channel 222 that extends from the nozzle 224 along a portion of the tip, terminating near, but not at, the working end 226. The channel 222 helps direct and focus the irrigation stream discharged through the nozzle 224 toward the working end 226. Because the tip portion 220 is similar/identical to the tip portion 126 of the configuration of FIGS. 7A-7F, the channel 222 can be included in that configuration as well. Conversely, the tip portion of the scaler tip of FIGS. 9A-9B can be omitted, resulting in a tip portion having the curved surface shown in FIGS. 7A-7F.

1-18. (canceled)

19. An apparatus for removing plaque, calculus, and other debris from teeth, comprising:
a scaler tip comprising a working end configured to engage and remove plaque, calculus, and other debris from the teeth, wherein the scaler tip comprises a nozzle configured to direct irrigation fluid toward the working end of the scaler tip;
a base unit comprising a fluid reservoir, a pump, a motor driver, and control electronics for controlling the operation of the pump and the motor driver;
a handheld unit comprising a handle portion configured to be handheld, the handheld unit being configured to receive and secure the scaler tip so that the scaler tip can be manipulated through handheld motion of the base unit; and
a cable connecting the base unit to the handheld unit, the cable comprising a fluid conduit and one or more wires;
wherein the handheld unit comprises:
a housing;
a motor for imparting oscillating or vibratory motion to the scaler tip when secured to the handheld unit, the motor being operable in response to the motor driver;
a fluid conduit configured to deliver irrigation fluid to the scaler tip so that the nozzle can direct a spray of the irrigation fluid toward the working end of the scaler tip; and
one or more user control inputs for communicating control commands to the control electronics of the base unit via the one or more wires of the cable;
wherein the scaler tip comprises a polymer material that forms the working end of the scaler tip.

20. The apparatus recited in claim 19, wherein the scaler tip has a curved configuration in which the working end terminates with a working edge configured to engage and remove the plaque, calculus, and debris, the nozzle being configured to direct the irrigation fluid spray toward the working edge.

21. The apparatus recited in claim 19, wherein the oscillating or vibratory motion imparted to the scaler tip is linear.

22. The apparatus recited in claim 19, wherein the motor comprises one of an eccentric weight vibration motor, a piezoelectric motor, and a magnetostrictive drive.

23. The apparatus recited in claim 22, wherein the housing comprises a handle portion and a body at a working end of the handle portion, the body being configured to receive a collar for securing the scaler tip to the housing, wherein the body comprises a fluid conduit configured to deliver irrigation fluid to the scaler tip, wherein the scaler tip comprises a base forming an annular shoulder configured to engage the collar to secure the scaler tip to the body with a bottom surface of the scaler tip engaging an end surface of the body, and wherein the body has a wall thickness that is at least double a wall thickness of the handle portion of the housing.

24. The apparatus recited in claim 23, wherein the wall thickness of the body is at least 3-6 times the thickness of the wall thickness of the handle portion of the housing.

25. The apparatus recited in claim 23, wherein the housing comprises first and second housing portions configured to be connected to define the handle portion, wherein the body is formed on one of the housing portions only.

26. The apparatus recited in claim 19, wherein the scaler tip comprises an irrigation port that extends from the base to the nozzle and is configured to deliver irrigation fluid from the handheld unit to the nozzle.

27. The apparatus recited in claim 26, wherein the body is configured to apply the oscillating or vibratory motion to the fluid passing through the channel so that waves are imparted in the fluid.

28. The apparatus recited in claim 23, wherein the handheld unit comprises a collar configured to engage an annular shoulder of the base of the scaler tip and to secure the scaler tip to the handheld unit via a compressive force that urges the scaler tip against the body.

29. The apparatus recited in claim 23, wherein the motor is configured to directly engage an end surface of the body opposite the end surface engaging the scaler tip.

30. The apparatus recited in claim 19, wherein the scaler tip comprises a stainless steel insert coated with the polymer material that forms the working end.

31. The apparatus recited in claim 19, wherein the scaler tip is formed completely of the polymer material that forms the working end.

32. The apparatus recited in claim 20, wherein the scaler tip further comprises a channel for receiving irrigation fluid from the nozzle, the channel being configured to direct the irrigation fluid toward the working end.

33. The apparatus recited in claim 19, wherein the oscillating of vibratory motion is applied at an ultrasonic frequency.

34. The apparatus recited in claim 33, wherein the oscillating of vibratory motion is applied at a frequency of 20-50 KHz.

35. The apparatus recited in claim 33, wherein the frequency is selectable to be continuous or pulsed.

36. The apparatus recited in claim 33, wherein the frequency is modulated to one or more patterns.
